(19) United States
(12) Patent Application Publication
(10) Pub. No.: US 2009/0066630 A1
(43) Pub. Date: Mar. 12, 2009

(54) IMAGE COMPENSATION METHODS AND IMAGE DISPLAY SYSTEMS

(75) Inventors: Mao-Lin Wu, Hsinchu County (TW); Tzu-Shiun Liu, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/853,048

(22) Filed: Sep. 11, 2007

(51) Int. Cl. G09G 3/36

(52) U.S. Cl. 345/102

(57) ABSTRACT

An image display system including a liquid crystal panel, a backlight, and a compensation device. The backlight emits light passing through the liquid crystal panel according to a control signal. The compensation device alters the liquid crystal orientation of the liquid crystal panel according to the intensity of light emitted from the backlight.

### BACKGROUND OF THE INVENTION

1. Field of the Invention

The invention relates to an image display system, and more particularly to an image display system having visual compensation.

2. Description of the Related Art

Liquid crystal display (LCD) screens are widely used in portable products due to their thin profile, light weight, and low radiation. A LCD device comprises a liquid crystal panel and a backlight. Since the liquid crystal panel itself does not emit light, the backlight is integrated as the light source of the LCD device.

Although backlights can provide sufficient and uniform brightness for LCD devices, they consume excessive power. When turning on an LCD screen of a portable electronic device, the battery power is rapidly consumed by the backlight. To reduce the rate of power consumption, the user may adjust the brightness of the backlight to extend the usage time.

There are several power consumption reduction methods proposed, for example, U.S. Pat. No. 6,812,659 discloses a device and method that can maintain the brightness of the reflective LCD by utilizing both the backlight and external light. The backlight control device controls a power supply to apply a backlight driving current within one of a plurality of selected backlight control ranges, wherein the backlight control ranges are different according to each of a detected ambient light intensity and the power source. As a result, the maximum value in the backlight control range will be set to a lower value if a higher ambient light intensity is detected.

### BRIEF SUMMARY OF THE INVENTION

Image compensation methods and image displaying systems are provided. An exemplary embodiment of an image compensation method for an image display system comprising a panel and a backlight emitting light through the panel. The image displaying system receives and displays a video signal. The amount of light passing through the panel is adjusted according to the intensity of the light emitted from the backlight.

An exemplary embodiment of an image display system comprises a liquid crystal panel, a backlight, and a compensation device. The backlight emits light passing through the liquid crystal panel according to a control signal. The compensation device alters the liquid crystal orientation of the liquid crystal panel according to the intensity of light emitted from the backlight.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an image display system;

FIG. 2 is a schematic diagram of an exemplary embodiment of adjusting the contrast of a video signal;

FIG. 3 is a schematic diagram of an embodiment of adjusting the brightness of the video signal;

FIG. 4 is a schematic diagram illustrating some embodiments of adjusting a difference between the video signal and a common signal; and

FIG. 5 is a schematic diagram of an embodiment of adjusting the edges of the video signal.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

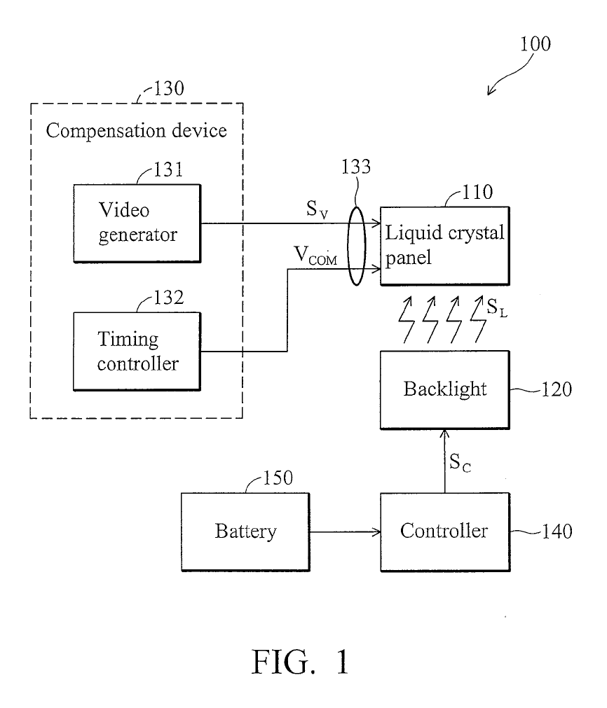

FIG. 1 is a schematic diagram of an exemplary embodiment of an image displaying system. Image display system 100 comprises a liquid crystal panel 110, a backlight 120, and a compensation device 130. The liquid crystal panel 110 displays images by setting liquid crystal orientation for each pixel. Since the liquid crystal panel 110 does not emit light, backlight 120, such as a cold cathode fluorescent lamp (CCFL) or a light emitting diode (LED), is utilized to provide light S_{L}. The controller 140 drives the backlight 120 to emit light with a specific level of brightness and regulates the brightness of the backlight 120 by selecting a voltage value based on a control signal. The compensation device 130 adjusts the amount of light S_{L} passing panel 110 according to the intensity of light S_{L} emitted from backlight 120 to compensate for visual discrepancy between different levels of intensity of emitted light S_{L}. In this embodiment, the compensation device 130 receives and adjusts a video signal to compensate for visual discrepancy.

The compensation device 130 outputs a group of signals 133 to the panel 110 for controlling orientation of the liquid-crystal units. The group of signals 133 comprises a video signal S_{V} and a common signal V_{COM}. In this embodiment, a video generator 131 generates the video signal S_{V} in accordance with the intensity of light S_{L} and a timing controller 132 generates the common signal V_{COM}, but the disclosure is not limited thereto. For example, the video generator may comprise a RGB generator and a digital to analog converter (DAC). In this case, the RGB generator adjusts the RGB value of a digital video signal in accordance with the intensity of light S_{L} and sends it to the DAC. The DAC then generates an analog video signal S_{V} for the panel 110. In some other embodiments, the video generator 131 adjusts an analog video signal in accordance with the intensity of light S_{L}.

Although the backlight 120 is the light source of the image display system 100, the brightness of each pixel shown by the panel 110 is determined by the orientation of the liquid crystal units, which is controlled by the group of signal 133. The orientation of each liquid crystal unit is set to a predetermined angle with respect to the cathodes by applying a predetermined voltage, and the predetermined angle results in a specific brightness of the corresponding pixel.

The backlight 120 consumes the most electricity, thus dimming the backlight 120 is the most effective way for power saving. The brightness of the backlight 120 is regulated by selecting a voltage according to a control signal. For example, when the intensity of light S_{L} emitted from backlight 120 exceeds a preset value as the image display system 100 is operating in a normal mode, the video generator 131 and timing controller 132 provide a video signal S_{V} and a common signal V_{COM} to the panel 110 in a usual way. The brightness of the image, displayed on the panel 110, is normal and does not require compensation.

When the intensity of light S_{L} emitted from backlight 120 is reduced as the image display system 100 is operating in a power-saving mode or for other reasons, video generator 131 or timing controller 132 generates an adjusted video signal S_{V} or an adjusted common signal V_{COM} to enhance the brightness of the image shown on the display. In some embodiments, the image display system only provides these two modes, normal and power-saving. However, in some other embodiments, the intensity of light emitted from the backlight may be set to one of a plurality of intensity levels. For example, the image display system supports two power-saving modes, mode 1 and 2 consume 80% and 50% of the original power respectively. When entering power-saving mode 1, the brightness of the backlight is slightly darker, and the compensation device 130 adjusts the video signal, the common signal, or both video and common signals to make the image more clearly by passing more light through the liquid crystal units. When entering power-saving mode 2, the light provided by the backlight is even weaker, so the compensation device 130 needs to do proper adjustment to either one or both of the video and common signals to compensate the brightness for visibility.

The proposed image compensation methods adjust either one or both of a corresponding video signal S_{V} or a corresponding common signal V_{COM} to compensate for the visual discrepancy between normal and power-saving modes.

In this embodiment, the image display system 100 further comprises a controller 140. The controller 140 generates a control signal S_{C} to the backlight 120 according to a power level of the battery or according to user settings to regulate the intensity of light S_{L} emitted from backlight 120.

When the power level of the battery is less than a preset value, the intensity of light S_{L} is reduced by controller 140 as the system 100 is switched to a power-saving mode. In some embodiments, the controller 140 may change the intensity of light S_{L} according to other reasons, such as ambient environment.

In some embodiments, the controller 140 is implemented by program codes, and the intensity of light S_{L} emitted from backlight 120 can be reduced when the battery is low or when the user triggers a power-saving mode.

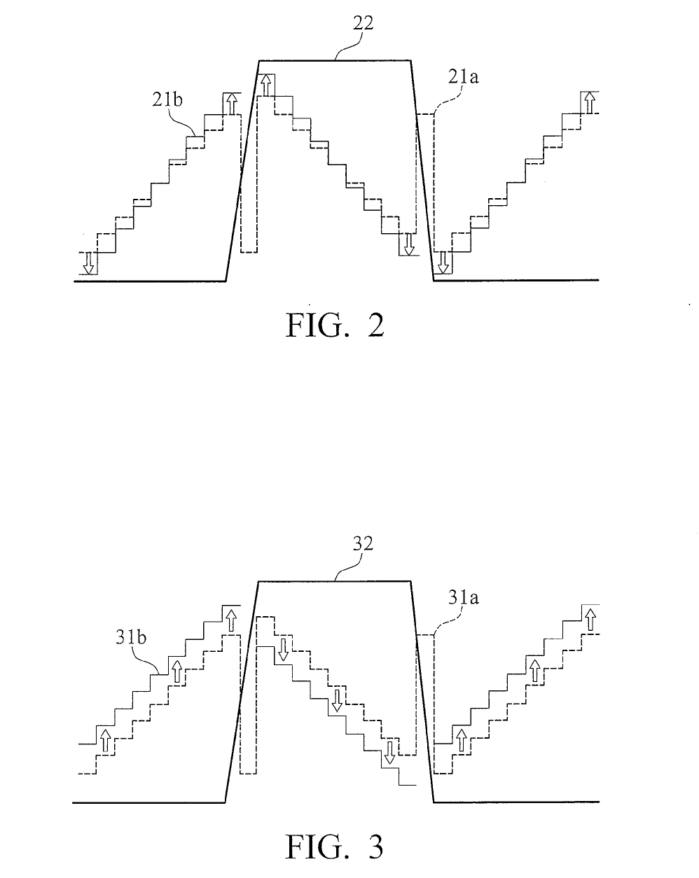

FIG. 2 is a schematic diagram showing an exemplary embodiment of a group of signals output from the compensation device 130 for panel control. A video signal shown as the dashed curve 21a in FIG. 2 is the original video signal generated to control the panel 110 when the image display system 100 is in a normal mode. When the image display system 100 is in a power-saving mode, the video signal is adjusted by the video generator 131 to enhance the contrast of the video signal (solid curve 21b).

In this embodiment, the contrast of the video signal is enhance by raising the luminance value (or the RGB value) of the parts that are relatively bright, and lowering the luminance value (or the RGB value) of the parts that are relatively dark. As a result, the slope of the video signal is increased by the video generator 131 such that contrast of the image, displayed on panel 110, between the normal and the power-saving modes is increased to compensate for visual discrepancy due to lower light intensity emitted from the backlight 120. The common signal 22 generated by the timing controller 132 in the power-saving mode is identical to the one in the normal mode.

FIG. 3 is a schematic diagram showing another exemplary embodiment of the group of signals used to control the panel 110. In this embodiment, the video generator 131 adjusts the video signal to increase the brightness. For example, the dashed curve 31a and curve 32 illustrate the video signal and the common signal when the image display system 100 is in the normal mode. When the image display system 100 is in a power-saving mode, the intensity of light S_{L} emitted from the backlight 120 is reduced to a preset value. The video generator 130 adjusts and output a video signal shown as the solid curve 31b.

The common signal 32 generated by the timing controller 132 is the same for both normal and power-saving modes. In a power-down mode, the video generator 131 amplifies the video signal such that the luminance or RGB value of the video signal is increased. The brightness of the image, displayed on panel 110, is thus increased to compensate for visual discrepancy.

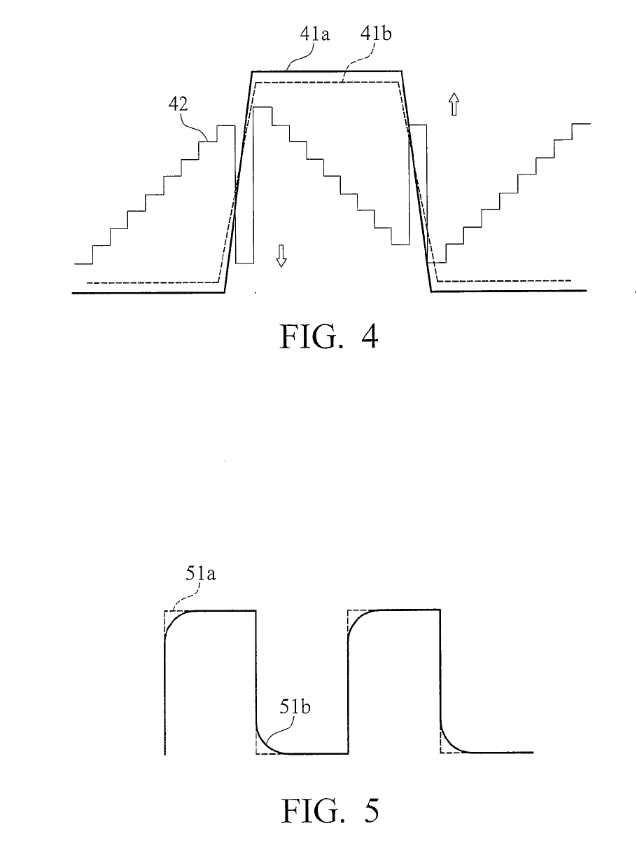

FIG. 4 is a schematic diagram showing another exemplary embodiment of the group of signals used to control the panel 110. In this embodiment, image brightness is enhanced by decreasing the difference between the video signal and the common signal. When the image display system 100 is in the normal mode, a common signal shown as a solid curve 41a is generated by the timing controller 132. When the image display system 100 is in a power-saving mode, the common signal is adjusted as shown as a dashed curve 41b by the timing controller 132.

The image brightness displayed on the LCD panel 110 is determined by the difference between the video and common signals. In this embodiment, the video signal 42 is the same in the normal and power-saving modes. When entering the power-saving mode, the light intensity emitted from the backlight 120 is darker than the light intensity in the normal mode, the timing controller 132 adjusts the common signal to decrease the voltage difference between the video signal and the common signal. As shown in FIG. 4, the common signal 41b is raised to a higher level when the slope of the video signal is positive, and it is lowered when the slope of the video signal is negative. The common signal can be controlled by hardware or software to alter the signal amplitude or DC bias. The brightness of the image, which is displayed on panel 110, is thus increased to compensate for visual discrepancy due to the darker backlight.

FIG. 5 is a schematic diagram showing an exemplary embodiment of the video signal used to drive the panel 110. When the image display system 100 is in a normal mode, a video signal shown as a dashed curve 51a is generated by the video generator 131. When the image display system 100 is in power-saving mode, a video signal shown as a solid curve 51b is generated by video generator 131.

In the normal mode, high sharpness of the image is desired, which can be achieved by eliminating distortions at the switching edges of the video signal as shown in the dashed curve 51a. In the power-saving mode, high image sharpness makes the image even more grayish with the dim backlight. In order to reduce the image sharpness, the video generator 131 adjusts the video signal 51b to smooth some rising and falling edges by hardware, software, or a combination of hardware and software. The adjusted video signal 51b is then used to control the liquid crystal units of the panel 110.

The amount of the light passing through the panel depends on the orientation of the liquid crystal units in the panel 110, and the liquid crystal units are controlled by the compensation device 130, embodiments of the present invention adjusts either or both of the video signal and common signal to make the image more clearly seen by the users when the backlight 120 becomes darker. The compensation methods described above may be implemented in analog or digital, and the panel 110 can be either an analog panel or a digital panel. For example, in a system operating digitally and having a digital panel, the RGB value carried by the digital video signal is adjusted and output to the panel directly. In a system operating digitally but having an analog panel, a digital to analog converter is required between the compensation device 130 and the panel 110.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image compensation method for an image display system comprising a panel and a backlight emitting light through the panel, comprising:
receiving a video signal for display on the image display system;
adjusting the amount of light passing through the panel according to the intensity of light emitted from the backlight.

2. The image compensation method as claimed in claim 1, wherein the video signal or a common signal is adjusted.

3. The image compensation method as claimed in claim 1, wherein in a normal mode, the intensity of light emitted from the backlight is equal to a first preset value and in a power-saving mode, the intensity of light emitted from the backlight is equal to a second preset value lower than the first preset value.

4. The image compensation method as claimed in claim 3, wherein in the power-saving mode, the video signal is adjusted by increasing the contrast of the video signal.

5. The image compensation method as claimed in claim 4, wherein in the power-saving mode, luminance values of the video signal are adjusted to increase the contrast of the video signal.

6. The image compensation method as claimed in claim 4, wherein in the power-saving mode, RGB values of the video signal are adjusted to increase the contrast of the video signal.

7. The image compensation method as claimed in claim 3, wherein in the power-saving mode, the video signal is adjusted by increasing the brightness of the video signal.

8. The image compensation method as claimed in claim 3, wherein in the power-saving mode, a difference between the video signal and a common signal is increased to increase the amount of light passing through the panel.

9. The image compensation method as claimed in claim 8, wherein the difference between the video and common signals is increased by decreasing the common signal through hardware or software or adjust the direct current (DC) bias of the common signal.

10. The image compensation method as claimed in claim 3, wherein in the power-saving mode, the video signal is adjusted to reduce the slope of a raising or falling edge of the video signal.

11. An image display system receiving and displaying a video signal, comprising:
a liquid crystal panel;
a backlight emitting light passes through the liquid crystal panel according to a control signal; and
a compensation device altering the liquid crystal orientation of the liquid crystal panel according to the intensity of light emitted from the backlight.

12. The image display system as claimed in claim 11, further comprising a digital to analog converter (DAC) coupled to the liquid crystal panel and the compensation device, wherein the DAC converts the video signal from analog to digital.

13. The image display system as claimed in claim 11, wherein the control signal determines the backlight operating in either a normal mode or a power-saving mode, in the normal mode, the intensity of light emitted from the backlight is equal to a first preset value, and in the power-saving mode, the intensity of light emitted from the backlight is equal to a second preset value lower than the first preset value.

14. The image display system as claimed in claim 13, wherein in the power-saving mode, the compensation device alters the liquid crystal orientation to increase the amount of light passing through the liquid crystal panel.

15. The image display as claimed in claim 11, wherein the compensation device alters the liquid crystal orientation by adjusting a difference between the video signal and a common signal.

16. The image display system as claimed in claim 11, wherein the compensation device adjusts the video signal to increase the contrast of the image.

17. The image display system as claimed in claim 16, wherein the compensation device adjusts the video signal to increase the contrast by increasing luminance values of the video signal.

18. The image display system as claimed in claim 16, wherein the compensation device adjusts the video signal to increase the contrast by adjusting RGB values of the video signal.

19. The image display system as claimed in claim 11, wherein the compensation device adjusts the video signal to increase the brightness of the image.

20. The image display system as claimed in claim 11, wherein the control signal is set by a user for controlling the amount of light emitting from the backlight.

21. The image display system as claimed in claim 11, further comprising a controller generating the control signal, when a battery level is below a threshold, the controller sends the control signal to reduce the amount of light emitting from the backlight.
